(19) United States
(12) Patent Application Publication
(10) Pub. No.: US 2026/0186690 A1
(43) Pub. Date: Jul. 2, 2026

(54) STORAGE CONTROLLER AND METHOD OF OPERATING THE SAME

(71) Applicant: Samsung Electronics Co., Ltd., Suwon-si (KR)

(72) Inventors: Kyungjune CHO, Suwon-si (KR); Beom Sig CHO, Suwon-si (KR)

(73) Assignee: Samsung Electronics Co., Ltd., Suwon-si (KR)

(21) Appl. No.: 19/246,337

(22) Filed: Jun. 23, 2025

(30) Foreign Application Priority Data
Dec. 31, 2024 (KR) 10-2024-0202207

(51) Int. Cl. G06F 3/06

(52) U.S. Cl. CPC G06F 3/0655; G06F 3/0604; G06F 3/0679

(57) ABSTRACT

Disclosed is a storage controller which includes a host interface and a storage processor. The host interface receives a write request, a write logical address range, and write data from a first host processor and receives first address translation information between the write logical address range and a storage region of a second host memory device associated with a second host processor. The storage processor transmits the write data to at least one non-volatile memory of a storage device and transmits the write data to the second host memory device based on receiving a read request for the write data from the first host processor and the first address translation information.

### CROSS-REFERENCE TO RELATED APPLICATION

This U.S. non-provisional application claims priority under 35 U.S.C. § 119 to Korean Patent Application No. 10-2024-0202207 filed on Dec. 31, 2024, in the Korean Intellectual Property Office, the disclosure of which is incorporated by reference herein in its entirety.

### BACKGROUND

Example embodiments relate to a storage controller and a method of operating the storage controller.

A storage device including non-volatile memories is widely being used. The storage device may have improved stability, improved endurance, relatively faster information access speed, and low-power consumption.

In an electronic system including a plurality of processors and a storage device, when processing data stored in the storage device, it may be advantageous to transmit data to be processed to another processor that may supplement the main processor or cooperate with the main processor instead of transmitting the data to the main processor. However, although processing workload may be reduced in the main processor, according to technologies developed up to date, operating overheads at the main processor may continue to occur.

### SUMMARY

Example embodiments of the present disclosure provide a storage controller for reducing the overhead occurring at a main processor of an electronic system and increasing or improving the efficiency at a system level.

Example embodiments of the present disclosure provide a method of operating the storage controller.

According to some example embodiments, a storage controller includes a host interface and a storage processor. The host interface receives a write request, a write logical address range, and write data from a first host processor and receives first address translation information between the write logical address range and a storage region of a second host memory device associated with a second host processor. The storage processor transmits the write data to at least one non-volatile memory of a storage device and transmits the write data to the second host memory device based on receiving a read request for the write data from the first host processor and the first address translation information.

According to some example embodiments, in a method of operating a storage controller, a write request, a write logical address range, and write data is received from a first host processor. First address translation information between the write logical address range and a storage region of a second host memory device associated with a second host processor are received from the first host processor. The write data is transmitted to at least one non-volatile memory of a storage device based on the write request and the write logical address range. Whether the write data is scheduled to be processed by the second host processor is determined based on the first address translation information, in response to receiving a read request and a read logical address range for the write data from the first host processor. The write data is transmitted to one of the first host processor and the second host processor based on a result of the determining.

According to some example embodiments, a storage controller includes a host interface and a storage processor. The host interface receives a write request, a write logical address range, and write data from a first host processor and receives address translation information between the write logical address range and a storage region of a second host memory device associated with a second host processor. The storage processor transmits the write data to at least one non-volatile memory of a storage device based on the write request and the write logical address range, determines whether the write data is scheduled to be processed by the second host processor, based on the address translation information, in response to receiving a read request for the write data from the first host processor, and transmits the write data to one of the first host processor and the second host processor based on a result of the determination.

According to some example embodiments, an electronic system includes a first host processor, a first host memory device, a second host processor, a second host memory device, and a storage controller. Each of the first host processor, the first host memory device, the second host processor, and the second host memory device are communicably coupled with each other and with the storage controller. The storage controller includes a host interface configured to receive a write request, a write logical address range, and write data from the first host processor and to receive first address translation information between the write logical address range and a storage region of the second host memory device; and a storage processor configured to transmit the write data to at least one non-volatile memory of a storage device and to transmit the write data to the second host memory device based on receiving a read request for the write data from the first host processor and the first address translation information. According to some example embodiments, the write data is scheduled to be processed by the second host processor. According to some example embodiments, the storage controller is configured to determine whether the write data is scheduled to be processed by the second host processor based on one of the write request and the first address translation information. According to some example embodiments, the storage controller is configured to, in response to determining that the write data is scheduled to be processed by the second host processor, receive the first address translation information after receiving the write request, the write logical address range, and the write data. According to some example embodiments, the first address translation information includes mapping information between the write logical address range and a physical address range of the storage region of the second host memory device.

### BRIEF DESCRIPTION OF THE FIGURES

The above and other objects and features of the present disclosure will become apparent by describing in detail embodiments thereof with reference to the accompanying drawings.

FIG. 1 is a block diagram of an electronic system including a storage device including a storage controller according to some example embodiments.

FIG. 2 is a diagram for describing relationships between a logical address and physical addresses of a first host memory device, a second host memory device, and a storage device of FIG. 1.

FIG. 3 is a diagram for describing address translation information between a logical address range and a storage region of a second host memory device and address translation information between a logical address range and a storage region of non-volatile memories of a storage device.

FIG. 4 is a block diagram of a storage controller of FIG. 1, according to some example embodiments.

FIG. 5A is a block diagram illustrating a non-volatile memory device of FIG. 1, according to some example embodiments.

FIG. 5B is a block diagram of a memory cell array of a non-volatile memory device of FIG. 5A, according to some example embodiments.

FIG. 5C is a block diagram of a memory block of FIG. 5A, according to some example embodiments.

FIG. 6 is a flowchart of a method of operating an electronic system including a storage controller of FIG. 4, according to some example embodiments.

FIG. 7A illustrates a first address translation table of FIG. 6, according to some example embodiments.

FIG. 7B illustrates a second address translation table of FIG. 6, according to some example embodiments.

FIG. 8 is a flowchart of a method of operating an electronic system including a storage controller according to some example embodiments.

FIG. 9 is a flowchart of a method of operating an electronic system including a storage controller according to some example embodiments.

FIG. 10 is a block diagram of a storage controller of FIG. 1, according to some example embodiments.

FIG. 11 is a flowchart of a method of operating an electronic system including a storage controller of FIG. 10, according to some example embodiments.

FIG. 12 is a block diagram of an electronic system including a storage device including a storage controller according to some example embodiments.

FIG. 13 is a flowchart of a method of operating a storage controller of FIG. 12, according to some example embodiments.

FIG. 14 is a flowchart of a method of operating a storage controller of FIG. 12, according to some example embodiments.

FIG. 15 is a block diagram of an electronic system including a storage device that further includes a storage controller, according to some example embodiments.

FIG. 16 is a flowchart of a method of operating a storage controller of FIG. 15, according to some example embodiments.

FIG. 17 is a flowchart of a method of operating a storage controller, according to some example embodiments.

FIG. 18 is a block diagram of an electronic system including a storage controller, according to some example embodiments.

### DETAILED DESCRIPTION

Below, example embodiments of the present disclosure will be described in detail and clearly to such an extent that one skilled in the art easily carries out the present disclosure.

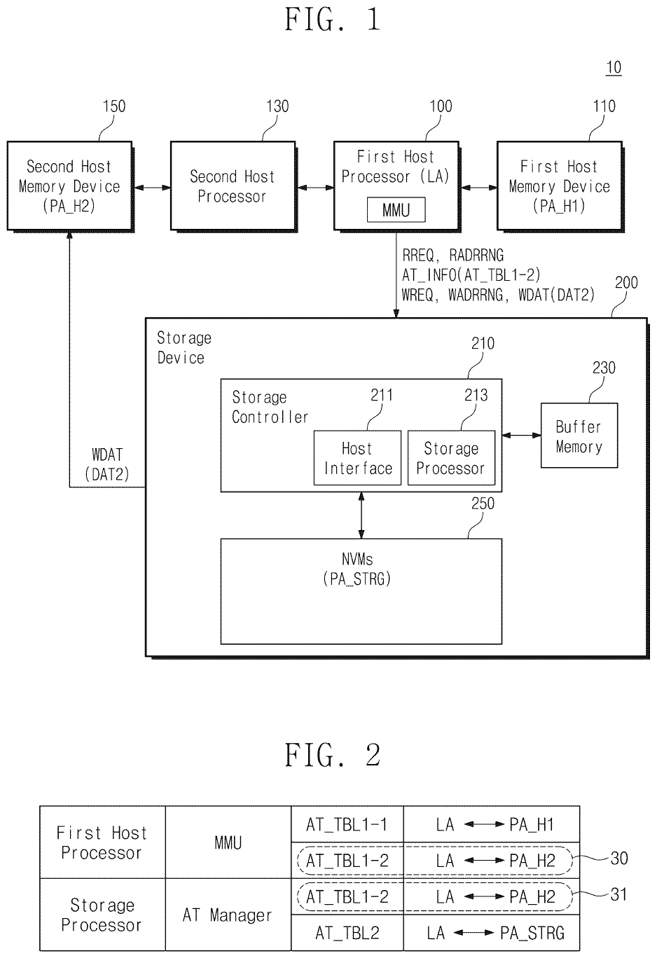

FIG. 1 is a block diagram of an electronic system including a storage device including a storage controller according to some example embodiments.

Referring to FIG. 1, an electronic system 10 may include a first host processor 100, a first host memory device 110, a second host processor 130, a second host memory device 150, and a storage device 200. The storage device 200 may include a storage controller 210, a buffer memory 230, and non-volatile memories (NVMs) 250. For example, the first host memory device 110 and the second host memory device 150 may have a relatively faster speed compared to the storage device 200. The first host memory device 110 may temporarily store pieces of data of a program being executed by the first host processor 100. The second host memory device 150 may temporarily store pieces of data of a program being executed by the second host processor 130. For example, the storage device 200 may have a relatively slower speed compared to the first host memory device 110 and the second host memory device 150 and may store or retain a large amount of data targeted for processing by the first host processor 100 and the second host processor 130.

The storage controller 210 may include a host interface 211 and a storage processor 213.

The host interface 211 may receive a write request WREQ, a write logical address range WADRRNG, and write data WDAT. The host interface 211 may receive first address translation information AT_INFO between the write logical address range WADRRNG and a storage region of the second host memory device 150 associated with the second host processor 130. For example, the first address translation information AT_INFO may include mapping information between the write logical address range WADRRNG and the storage region of the second host memory device 150.

In some example embodiments, a time point at which the first address translation information AT_INFO is input to the host interface 211 from the first host processor 100 may follow a time point at which the write request WREQ, the write logical address range WADRRNG, or the write data WDAT are received, but example embodiments are not limited thereto. In some example embodiments, the time point at which the first address translation information AT_INFO is input to the host interface 211 from the first host processor 100 may precede the time point at which the write request WREQ, the write logical address range WADRRNG, or the write data WDAT are received. For example, the first address translation information AT_INFO may be received from the first host processor 100 at a time point at which the storage device 200 is initialized (or at a time point at which the storage device 200 is powered on).

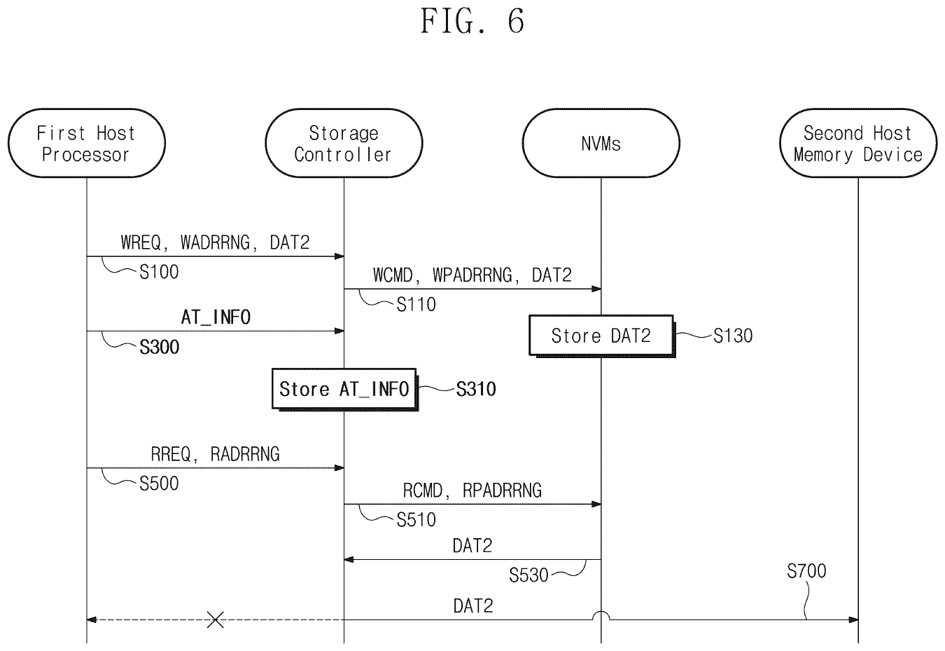

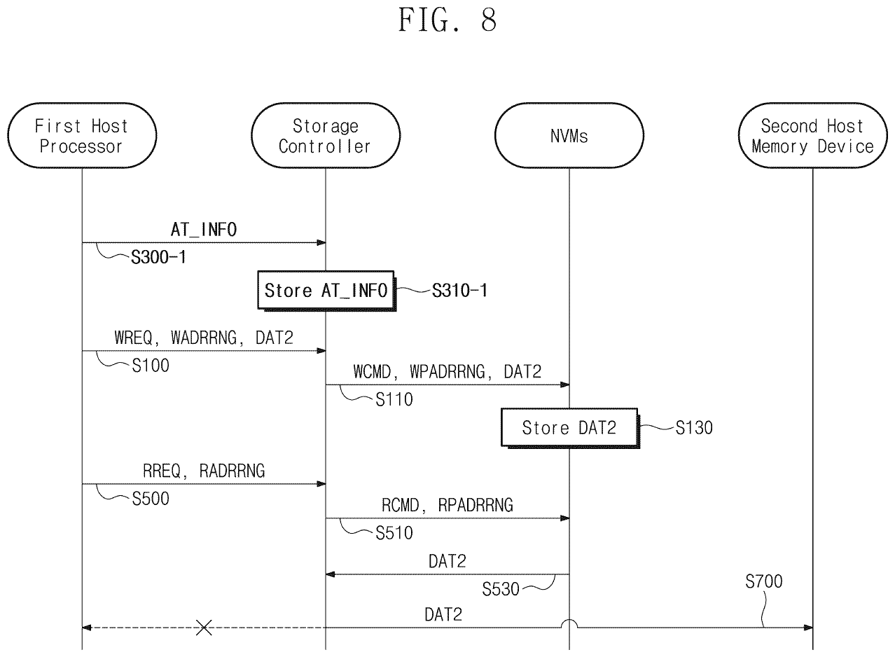

In the example embodiment illustrated in FIG. 1, the write data WDAT may include data (e.g., DAT2) scheduled to be processed by the second host processor 130. For example, in the specification, “2” of DAT2 may indicate that the corresponding data is scheduled to be processed by the second host processor 130, and “1” of DAT1 may indicate that the corresponding data is scheduled to be processed by the first host processor 100. For example, whether the write data WDAT are data scheduled to be processed by the second host processor 130 may be indicated by (or included in) one of the write request WREQ and the first address translation information AT_INFO, which will be described with reference to FIGS. 6 and 8.

In the example embodiment illustrated in FIG. 1, the first address translation information AT_INFO may include mapping information between the write logical address range WADRRNG and a physical address range of the storage region of the second host memory device 150, for example, in the form of a table (e.g., AT_TBL1-2). For example, in the specification, “2” of AT_TBL1-2 may indicate that the corresponding mapping information includes a mapping relationship with the second host memory device 150, and “1” (e.g., “1” following “-”) of AT_TBL1-1 may indicate that the corresponding mapping information includes a mapping relationship with the first host memory device 110. For example, the first host processor 100 may manage a logical address LA. The first host memory device 110 may include a storage region defined by a physical address PA_H1, and the second host memory device 150 may include a storage region defined by a physical address PA H2. The storage device 200 may include a storage region defined by a physical address PA_STRG. For example, the first address translation information AT_INFO may include mapping information between the write logical address range WADRRNG included in the logical address LA and a physical address range included in the physical address PA H2.

The storage processor 213 may transfer write data WDAT (DAT2) to the non-volatile memories 250 of the storage device 200. For example, the storage processor 213 may write the write data WDAT (DAT2) in the non-volatile memories 250 of the storage device 200.

In some example embodiments, the storage processor 213 may store the first address translation information AT_INFO in the buffer memory 230 or the non-volatile memories 250 of the storage device 200.

The storage processor 213 may receive a read request RREQ and a read logical address range RADRRNG associated with the write data WDAT from the first host processor 100.

The storage processor 213 may transmit the write data WDAT to the second host memory device 150 based on the first address translation information AT_INFO and receiving the read request RREQ from the first host processor 100.

In some example embodiments, as described above, data DAT2 may be data scheduled to be processed by the second host processor 130, and the data DAT2 may be processed by the second host processor 130 more efficiently than by the first host processor 100. For example, the first host processor 100 may be a main processor, and the second host processor 130 may be any other processor for supplementing the first host processor 100 or cooperating with the first host processor 100.

For example, the first host processor 100 may be a central processing unit (CPU), and the second host processor 130 may be a graphic processing unit (GPU). In this case, the GPU may perform complicated calculations such that 3D rendering in a relatively shorter time, and the CPU may perform subsequent processing based on a processing result. The GPU may be effective for the learning of a deep learning model, and the CPU may prepare training data or may analyze a training result.

For example, the first host processor 100 may be a CPU, and the second host processor 130 may be a digital signal processor (DSP) or an artificial intelligence (AI) accelerator. However, example embodiments are not limited thereto.

In some example embodiments, the transmission of the write data WDAT (DAT2) to the second host memory device 150 may be performed based on direct memory access (DMA) feature. For example, the storage device 200 may further include a first DMA engine, the second host memory device 150 (or a second host device including the second host processor 130 and the second host memory device 150) may further include a second DMA engine, and the write data WDAT (DAT2) may be transmitted from the first DMA engine to the second DMA engine by using the DMA manner.

In some example embodiments, the storage controller 210 may implement an address translation service (ATS), which is provided by the first host processor 100 based on the first address translation information AT_INFO, within the storage controller 210. Below, operations to receive, store, compress, and refer to the first address translation information AT_INFO will be described with reference to FIGS. 6, 8, 9, and 11 as different example embodiments for implementing the ATS within the storage controller 210. For example, instead of the first host processor 100, the storage controller 210 may emulate the ATS in the process of transmitting the write data WDAT (DAT2) to the second host memory device 150 based on the first address translation information AT_INFO. For example, the storage controller 210 may perform or implement an in-storage ATS.

According to the configuration of some example embodiments, when data transferred from the first host processor are scheduled to be processed by the second host processor, instead of the first host processor, a storage controller according to example embodiments may directly transmit the data to a second host memory device associated with the second host processor based on address translation information. Also, the storage controller may perform the transmission to the second host memory device through a dedicated port of the storage device and may set or adjust the processing speed of the dedicated port. Accordingly, in an electronic system including the first host processor, the second host processor, and the storage device, it may be possible to reduce the overhead occurring at the first host processor and to provide a memory architecture increasing the efficiency at the system level of the electronic system.

FIG. 2 is a diagram for describing relationships between a logical address and physical addresses of a first host memory device, a second host memory device, and a storage device of FIG. 1.

Referring to FIGS. 1 and 2, the first host processor 100 may manage an address translation table AT_TBL1-1 including mapping information between the logical address LA and the physical address PA_H1 and an address translation table AT_TBL1-2 including mapping information between the logical address LA and the physical address PA_H2.

In some example embodiments, the first host processor 100 may manage the address translation tables AT_TBL1-1 and AT_TBL1-2 by using a memory management device (MMU). For example, the first host processor 100 may sequentially execute instructions included in a program in the process of executing the program, may generate a logical address to load pieces of data to be used in the instructions, and may generate, change, or remove all or some of the address translation tables AT_TBL1-1 and AT_TBL1-2 by using the memory management device to translate the logical address into a physical address.

The storage processor 213 may manage the address translation table AT TBL1-2 and an address translation table AT_TBL2 including mapping information between the logical address LA and the physical address PA_STRG.

In some example embodiments, the storage processor 213 may manage the address translation tables AT_TBL1-2 and AT_TBL2 by using an address translation manager (AT manager), but example embodiments are not limited thereto.

As described with reference to FIG. 1, the address translation table AT_TBL1-2, denoted by reference numeral “31”, which is managed by the storage processor 213 and the address translation table AT_TBL1-1, denoted by the reference numeral “30”, which is generated by the memory management device under control of the first host processor 100 and may be transmitted from the first host processor 100.

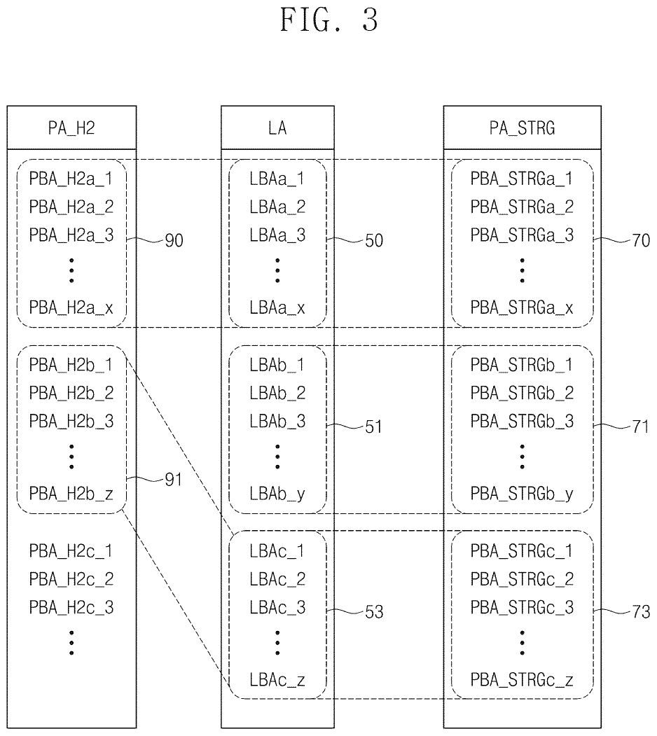

FIG. 3 is a diagram for describing address translation information between a logical address range and a storage region of a second host memory device and address translation information between a logical address range and a storage region of non-volatile memories of a storage device.

Referring to FIGS. 1, 2, and 3, the logical address LA may include logical address ranges LBAa_1, LBAa_2, LBAa_3, . . . , LBAa_x (x being an integer of 4 or more), LBAb_1, LBAb_2, LBAb_3, . . . , LBAb_y (y being an integer of 4 or more), and LBAc_1, LBAc_2, LBAc_3, . . . , LBAc_z (z being an integer of 4 or more).

The physical address PA_H2 may include physical address ranges PBA_H2a_1, PBA H2a_2, PBA_H2a_3, . . . , PBA_H2a_x (x being an integer of 4 or more), PBA_H2b_1, PBA H2b_2, PBA_H2b_3, . . . , PBA_H2b_z (z being an integer of 4 or more), and PBA_H2c_1, PBA_H2c_2, PBA_H2c_3, . . . , etc.

The physical address PA_STRG may include physical address ranges PBA STRGa_1, PBA_STRGa_2, PBA_STRGa_3, . . . , PBA_STRGa_x (x being an integer of 4 or more), PBA_STRGb_1, PBA_STRGb_2, PBA_STRGb_3, . . . , PBA_STRGb_y (y being an integer of 4 or more), and PBA_STRGc_1, PBA_STRGc_2, PBA_STRGc_3, . . . , PBA_STRGc_z (z being an integer of 4 or more).

As illustrated in FIG. 3, logical address range 50 may correspond to physical address ranges 70 and 90, logical address range 51 may correspond to physical address range 71, and logical address range 53 may correspond to physical address ranges 73 and 91.

For example, the logical address ranges 50, 51, and 53 may be write logical address ranges for performing the write operation of the storage device 200, and pieces of write data corresponding to the write operation may be stored in the non-volatile memories 250 of the storage device 200, which the physical address ranges 70, 71, and 73 indicate. The pieces of write data stored in the storage region of the non-volatile memories 250, which the physical address ranges 70, 71, and 73 indicate, may correspond to the data DAT2 scheduled to be processed by the second host processor 130, which is described with reference to FIG. 1 and may be transmitted (or moved) to a storage region of the second host memory device 150, which the physical address ranges 90 and 91 indicate. Accordingly, through the logical address ranges 50 and 53, there may be defined a mapping relationship between the physical address ranges 70 and 73 and the physical address ranges 90 and 91, which indicate the storage region of the second host memory device 150.

For example, the pieces of write data stored in the storage region of the non-volatile memories 250, which the physical address range 71 indicate, may not correspond to the data DAT2. Accordingly, the mapping relationship between the physical address range 71 and the physical address ranges indicating the storage region of the second host memory device 150 may be indeterminate (or may not be defined).

In some example embodiments, in the address translation table AT TBL2 and the address translation table AT TBL1-2 described with reference to FIG. 2, the address translation table AT_TBL2 may include the mapping relationship between the logical address ranges 50, 51, and 53 and the physical address ranges 70, 71, and 73, and the address translation table AT_TBL1-2 may include the mapping relationship between the logical address ranges 50 and 53 and the physical address ranges 90 and 91.

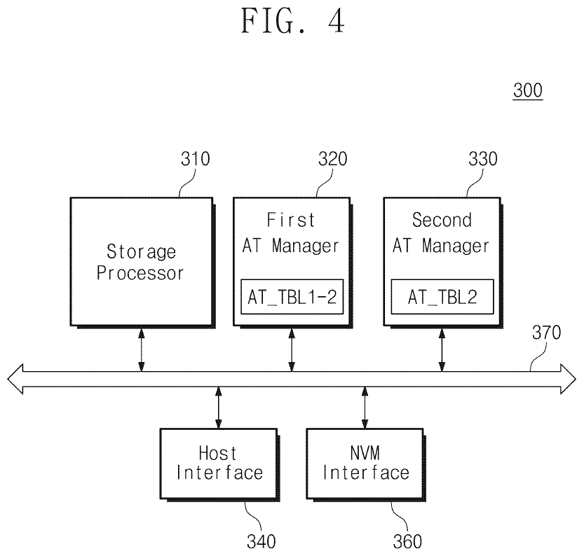

FIG. 4 is a block diagram illustrating a storage controller of FIG. 1, according to some example embodiments.

Referring to FIG. 4, a storage controller 300 may correspond to the storage controller 210 of FIG. 1.

The storage controller 300 may include a storage processor 310, a first address translation (AT) manager 320, a second address translation manager 330, a host interface 340, an NVM interface 360, and a bus 370. The storage processor 310 may correspond to the storage processor 213 of FIG. 1, and the host interface 340 may correspond to the host interface 211 of FIG. 1. The first address translation manager 320 may include the address translation table AT TBL1-2, and the second address translation manager 330 may include the address translation table AT TBL2.

The storage processor 310 may control or direct overall operations of the components 320, 330, 340, 360, and 370 of the storage controller 300. The bus 370 may perform communication between the components 310, 320, 330, 340, and 360 of the storage controller 300.

When the write request, the write logical address range, and the write data are received from a first host processor (e.g., 100 of FIG. 1) through the host interface 340, the storage processor 310 may write the write data in non-volatile memories (e.g., 250 of FIG. 1) through the NVM interface 360 based on the write logical address range and the address translation table AT TBL2.

When first address translation information (e.g., AT_INFO of FIG. 1) is received from the first host processor through the host interface 340, the storage processor 310 may write the first address translation information in the first address translation manager 320.

When a read request and a read logical address range for the write data are received from the first host processor through the host interface 340, the storage processor 310 may read the write data from the non-volatile memories through the NVM interface 360 based on the read logical address range and the address translation table AT_TBL2 and may transmit the write data to a second host processor (e.g., 150 of FIG. 1) based on the address translation table AT TBL1-2.

In some example embodiments, the storage controller 300 may further include a DMA engine for performing the DMA feature described with reference to FIG. 1, but example embodiments are not limited thereto.

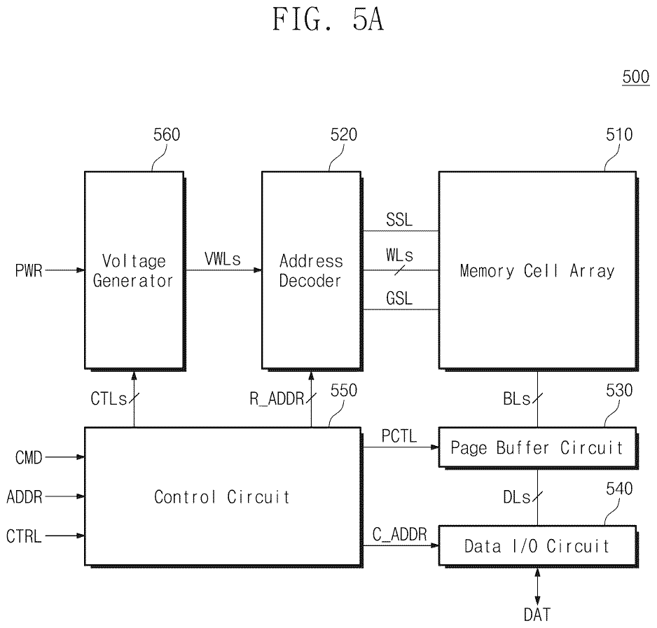

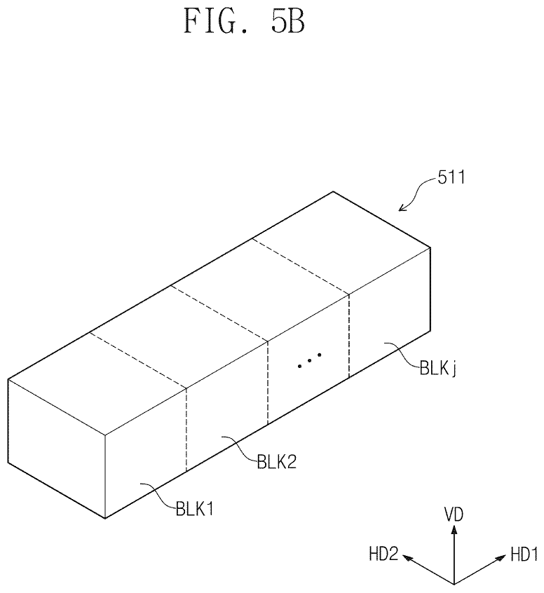

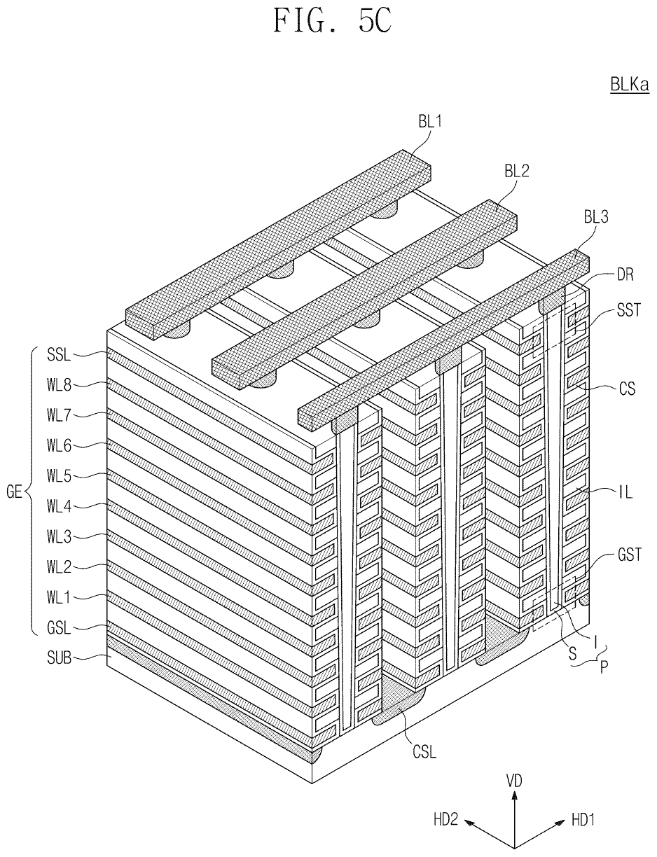

FIG. 5A is a block diagram illustrating a non-volatile memory device of FIG. 1.

Referring to FIG. 5A, a non-volatile memory device 500 may include a memory cell array 510, an address decoder 520, a page buffer circuit 530, a data input/output circuit 540, a control circuit 550, and a voltage generator 560.

The memory cell array 510 may be connected to the address decoder 520 through a string selection line SSL, a plurality of word lines WLs, and a ground selection line GSL. Also, the memory cell array 510 may be connected to the page buffer circuit 530 through a plurality of bit lines BLs. The memory cell array 510 may include a plurality of memory cells connected to the plurality of word lines WLs and the plurality of bit lines BLs.

In some example embodiments, the memory cell array 510 may be a three-dimensional (3D) memory cell array formed on a substrate in a 3D (or vertical) structure. The memory cell array 510 may include vertical memory cell strings including a plurality of memory cells stacked and formed.

The control circuit 550 may receive a control signal CTRL, a command CMD, and an address ADDR from a storage controller and may control a program loop, a read operation, and an erase operation of the non-volatile memory device 500 based on the control signal CTRL, the command CMD, and the address ADDR.

For example, the control circuit 550 may generate control signals CTLs for controlling the voltage generator 560 and a page buffer control signal PCTL for controlling the page buffer circuit 530 based on the command CMD, and may generate a row address R ADDR and a column address C_ADDR based on the address ADDR. The control circuit 550 may provide the row address R_ADDR to the address decoder 520 and may provide the column address C_ADDR to the data input/output circuit 540.

The address decoder 520 may be connected to the memory cell array 510 through the string selection line SSL, the plurality of word lines WLs, and the ground selection line GSL. In the write operation or the read operation, based on the row address R_ADDR from the control circuit 550, the address decoder 520 may determine one of the plurality of word lines WLs as a selected word line and may determine the remaining word lines among the plurality of word lines WLs other than the selected word line as unselected word lines.

The voltage generator 560 may generate word line voltages VWLs used for the operation of the non-volatile memory device 500 based on the control signals CTLs provided from the control circuit 550. The word line voltages VWLs generated from the voltage generator 560 may be applied to the plurality of word lines WLs through the address decoder 520.

For example, in an erase operation, the voltage generator 560 may apply an erase voltage to a well of a memory block and may apply a word line erase voltage (i.e., a ground voltage) to all the word lines of the memory block. In the erase verify operation, the voltage generator 560 may apply an erase verify voltage to all the word lines of one memory block or may apply the erase verify voltage in units of word line.

For example, in the write operation, the voltage generator 560 may apply a program voltage to the selected word line and may apply a program pass voltage to the unselected word lines. Also, in the program verify operation, the voltage generator 560 may apply a program verify voltage to the selected word line and may apply a verify pass voltage to the unselected word lines. In addition, in the read operation, the voltage generator 560 may apply a read voltage to the selected word line and may apply a read pass voltage to the unselected word lines.

The page buffer circuit 530 may be connected to the memory cell array 510 through the plurality of bit lines BLs. The page buffer circuit 530 may include a plurality of page buffers. The page buffer circuit 530 may temporarily store data to be written at a selected page in the write operation or data read from the selected page in the read operation.

The data input/output circuit 540 may be connected to the page buffer circuit 530 through a plurality of data lines DLs. In the write operation, the data input/output circuit 540 may receive data DAT from the storage controller and may provide the data DAT to the page buffer circuit 530 based on the column address C_ADDR provided from the control circuit 550. In the read operation, the data input/output circuit 540 may provide the storage controller with the data DAT stored in the page buffer circuit 530 based on the column address C_ADDR provided from the control circuit 550.

FIG. 5B is a block diagram of a memory cell array of a non-volatile memory device of FIG. 5A, according to some example embodiments.

Referring to FIG. 5B, a memory cell array 511 may include a plurality of memory blocks BLK1, BLK2, . . . , BLKj (j being an integer of 3 or more) disposed along a first horizontal direction HD1, a second horizontal direction HD2, and a vertical direction VD. In some example embodiments, memory blocks may be selected by the address decoder 520 of FIG. 5A. For example, the address decoder 520 may select a memory block corresponding to a block address from among the plurality of memory blocks BLK1 to BLKj.

FIG. 5C is a block diagram of a memory block of FIG. 5A, according to some example embodiments.

Referring to FIG. 5C, a memory block BLKa may correspond to one of the plurality of memory blocks BLK1 to BLKj of FIG. 5B. The memory block BLKa may be formed in a direction perpendicular to a substrate SUB. The substrate SUB is of a first conductivity type (e.g., a p-type), and a common source line CSL which extends along the second horizontal direction HD2 and is doped with impurities of a second conductivity type (e.g., an n-type) is provided on the substrate SUB. On a region of the substrate SUB between two adjacent common source lines CSL, a plurality of insulating layers IL which extend along the second horizontal direction HD2 are sequentially provided along the vertical direction VD, and the plurality of insulating layers IL are spaced apart from each other along the vertical direction VD as much as a specific distance. For example, each of the plurality of insulating layers IL may include an insulating material such as silicon oxide.

A plurality of pillars “P” which are sequentially disposed along the first horizontal direction HD1 and penetrate the plurality of insulating layers IL along the vertical direction VD are provided on the region of the substrate SUB between the two adjacent common source lines CSL. For example, the plurality of pillars “P” may be in contact with the substrate SUB through the plurality of insulating layers IL. A surface layer “S” of each pillar “P” may include a silicon material of a first type and may function as a channel. Meanwhile, an inner layer “I” of each pillar “P” may include an insulating material such as silicon oxide or an air gap.

In the region between the two adjacent common source lines CSL, a charge storage layer CS may be provided along exposed surfaces of the insulating layers IL, the pillars “P”, and the substrate SUB. The charge storage layer CS may include a gate insulating layer (or referred to as a “tunneling insulating layer”), a charge trap layer, and a blocking insulating layer. For example, the charge storage layer CS may have an oxide-nitride-oxide (ONO) structure. Furthermore, in the region between the two adjacent common source lines CSL, gate electrodes GE such as the selection lines GSL and SSL and the word lines WL1 to WL8 may be provided on an exposed surface of the charge storage layer CS.

Drains or drain contacts DR may be respectively provided on the plurality of pillars “P”. For example, each of the drains or drain contacts DR may include a silicon material which is doped with impurities of the second conductivity type. The bit lines BL1 to BL3 which extend in the first horizontal direction HD1 and are spaced apart from each other along the second horizontal direction HD2 as much as a specific distance may be provided on the drains DR.

FIG. 6 is a flowchart illustrating a method of operating an electronic system including a storage controller of FIG. 4, according to some example embodiments.

Referring to FIG. 6, a first host processor (e.g., 100 of FIG. 1) may transmit the write request WREQ, the write logical address range WADRRNG, and the data DAT2 to a storage controller (e.g., 210 of FIG. 1 or 300 of FIG. 4) (S100).

The storage controller may transmit a write command WCMD, a write physical address range WPADRRNG, and the data DAT2 to the non-volatile memories based on the write request WREQ and the write logical address range WADRRNG (S110), and the non-volatile memories (e.g., 250 of FIG. 1) may store the data DAT2 based on the write command WCMD and the write physical address range WPADRRNG (S130).

The first host processor may transmit the first address translation information AT_INFO to the storage controller.

The storage controller may store the first address translation information AT_INFO (S310).

The first host processor may transmit the read request RREQ and the read logical address range RADRRNG to the storage controller (S500).

The storage controller may transmit a read command RCMD and a read physical address range RPADRRNG to the non-volatile memories based on the read request RREQ and the read logical address range RADRRNG (S510) and may read the data DAT2 from the non-volatile memories based on the read command RCMD and the read physical address range RPADRRNG (S530).

The storage controller may transmit the data DAT2 to a second host memory device (e.g., 150 of FIG. 1) based on receiving the read request RREQ from the first host processor and the first address translation information AT_INFO (S700).

In the example embodiment illustrated in FIG. 6, write data, for example, the data DAT2 scheduled to be processed by the second host processor may be indicated by the write request WREQ. For example, the write request WREQ may include information indicating that the write data are data scheduled to be processed by the second host processor. For example, the write request WREQ may include a first field indicating that the write data are data scheduled to be processed by the second host processor.

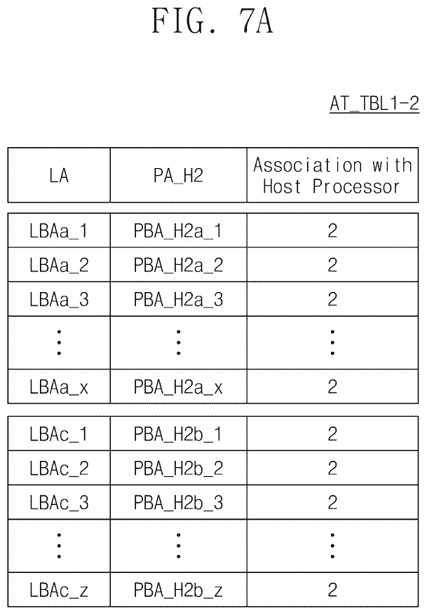

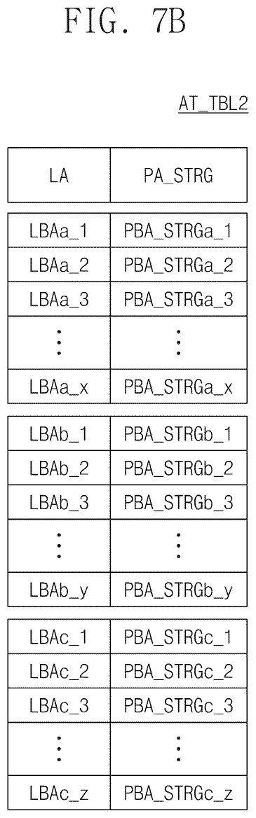

In some example embodiments, based on the write request WREQ, the storage controller may determine whether the write data are the data DAT2 scheduled to be processed by the second host processor. For example, the storage controller may determine whether the write data are the data DAT2 scheduled to be processed by the second host processor, by determining the first field included in the write request WREQ includes a first value. For example, when the first field includes the first value, the storage controller may determine that the write data are the data DAT2 scheduled to be processed by the second host processor; when the first field does not include the first value, the storage controller may determine that the write data are not the data DAT2 scheduled to be processed by the second host processor. FIG. 7A illustrates a first address translation table of FIG. 6, according to some example embodiments, and FIG. 7B illustrates a second address translation table of FIG. 6, according to some example embodiments.

In FIGS. 7A and 7B, the first address translation table AT_TBL1-2 and the second address translation table AT_TBL2 may be based on the mapping relationship between the logical address LA and the physical addresses PA_H2 and PA_STRG described with reference to FIG. 3.

Referring to FIG. 7A, the first address translation table AT_TBL1-2 may include the logical address LA and the physical address PA H2.

In some example embodiments, the first address translation table AT_TBL1-2 may further include association with a host processor. For example, in the example embodiment illustrated in FIG. 7A, referring to the last column of each entry of the first address translation table AT TBL1-2, the association may indicate that data corresponding to the logical address ranges LBAa_1 to LBAa_x and LBAc_1 to LBAc_z or the physical address ranges PBA H2a_1 to PBA H2a_x and PBA H2b 1 to PBA H2b z are data scheduled to be processed by the second host processor (e.g., “2” expressed in the association column may indicate the second host processor). For sake of description, when the electronic system 10 (FIG. 1) includes a third host processor in addition to the second host processor, the third host processor may be defined or selected when “3” is expressed in the association column. The association may be written by the first host processor or the storage controller.

Referring to FIG. 7B, the second address translation table AT_TBL2 may include the logical address LA and the physical address PA STRG.

In some example embodiments, the second address translation table AT_TBL2 may correspond to a flash translation layer (FTL) of a conventional storage device.

FIG. 8 is a flowchart illustrating a method of operating an electronic system including a storage controller according to some example embodiments.

In the example embodiment illustrated in FIG. 8, relative to the example embodiment illustrated in FIG. 6, the write data, for example, data DAT2 scheduled to be processed by a second host processor may be indicated by the first address translation information AT_INFO, instead of the write request WREQ. For example, the first address translation information AT_INFO may include information indicating that the write data are data scheduled to be processed by the second host processor. For example, the first address translation information AT_INFO may include association information indicating that the write data are data scheduled to be processed by the second host processor (e.g., the association in the last column of each entry of the first address translation table AT TBL1-2 of FIG. 7A). Thus, additional description will be omitted to avoid redundancy.

In some example embodiments, based on the first address translation information AT_INFO, the storage controller may determine whether the write data are the data DAT2 scheduled to be processed by the second host processor. For example, the storage controller may determine whether the write data are the data DAT2 scheduled to be processed by the second host processor, by determining whether the association information included in the write request WREQ includes a first value (e.g., “2” being a value of the association described with reference to FIG. 7A). For example, when the association information includes the first value, the storage controller may determine that the write data are the data DAT2 scheduled to be processed by the second host processor; when the association information does not include the first value, the storage controller may determine that the write data are not data scheduled to be processed by the second host processor.

A first host processor may transmit the first address translation information AT_INFO to the storage controller (S300-1).

The storage controller may store the first address translation information AT_INFO (S310-1).

In some example embodiments, operation S310-1 may be performed before the write request WREQ, the write logical address range WADRRNG, or the write data WDAT are received. For example, the first address translation information AT_INFO may be received from the first host processor 100 at a time point at which the storage device 200 is initialized (or at a time point at which the storage device 200 is powered on). The storage controller may store the first address translation information AT_INFO in the buffer memory or the non-volatile memories at the time point at which the storage device 200 is initialized.

The storage controller may transmit the write command WCMD and the write physical address range WPADRRNG, and the data DAT2 to non-volatile memories (e.g., 250 of FIG. 1) based on the write request WREQ and the write logical address range WADRRNG (S110), and the non-volatile memories may store the data DAT2 in the non-volatile memories based on the write command WCMD and the write physical address range WPADRRNG (S130).

The first host processor may transmit the read request RREQ and the read logical address range RADRRNG to the storage controller (S500).

The storage controller may transmit the read command RCMD and the read physical address range RPADRRNG to the non-volatile memories based on the read request RREQ and the read logical address range RADRRNG (S510) and may read the data DAT2 from the non-volatile memories based on the read command RCMD and the read physical address range RPADRRNG (S530).

The storage controller may transmit the data DAT2 to a second host memory device (e.g., 150 of FIG. 1) based on receiving the read request RREQ from the first host processor and the first address translation information AT_INFO (S700).

In the example embodiments illustrated in FIG. 8, operation S300-1 and operation S310-1 may be performed before operation S100, but example embodiments are not limited thereto.

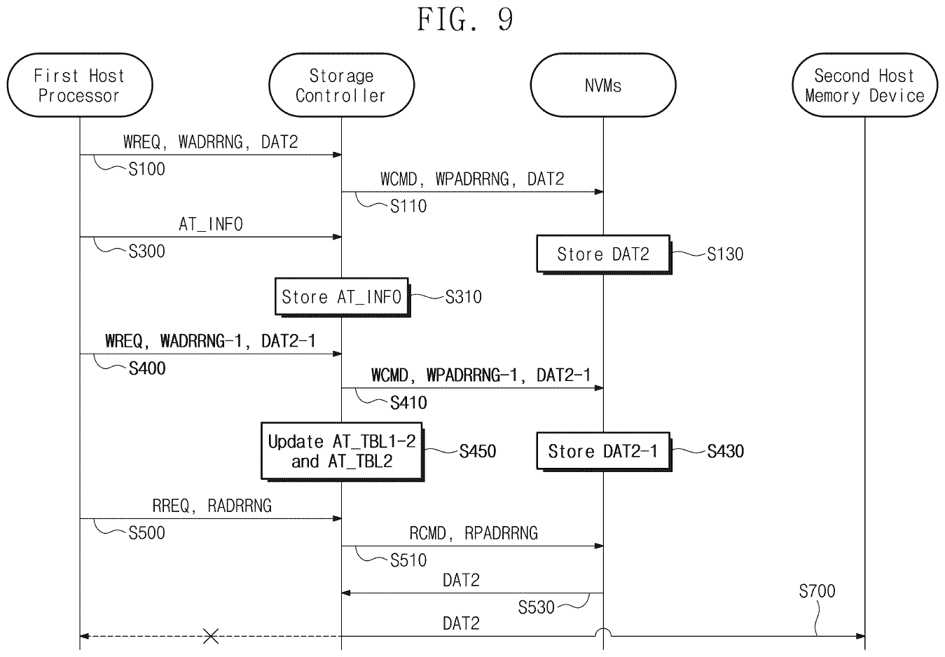

FIG. 9 is a flowchart of a method of operating an electronic system including a storage controller according to some example embodiments.

In some embodiments illustrated in FIG. 9, relative to the example embodiment illustrated in FIG. 6, after the data DAT2 are written in the non-volatile memories through operation S100, operation S110, and operation S130, data DAT2-1 obtained by changing all or portion of the data DAT2 through operation S400, operation S410, and operation S430 may be additionally written in the non-volatile memories. The operations in FIG. 9 may be best understood with reference to FIG. 6 and therefore may be best understood with reference thereto where like numerals indicate like elements not described again in detail.

In some example embodiments, operation S100, operation S110, operation S130, operation S300, operation S310, operation S500, operation S510, operation S530, operation S700 may be same as or similar in some respects to the operations in FIG. 6, and may be best understood with reference thereto.

The storage controller may transmit the write command WCMD, a write physical address range WPADRRNG-1, and the data DAT2-1 to non-volatile memories based on the write request WREQ and a write logical address range WADRRNG-1 (S410) and the non-volatile memories may store the data DAT2-1 in the non-volatile memories based on the write command WCMD and the write physical address range WPADRRNG-1 (S430).

The storage controller may update the first address translation table AT_TBL1-2 and the second address translation table AT TBL2.

For example, as all or portion of the data DAT2 is changed to the data DAT2-1, in the first address translation table AT_TBL1-2 or the second address translation table AT TBL2 described with reference to FIGS. 7A and 7B, all or some of physical address ranges included in the physical addresses PA_H2 and PA_STRG may be changed together, and thus, the first address translation table AT_TBL1-2 and the second address translation table AT_TBL2 may be updated together.

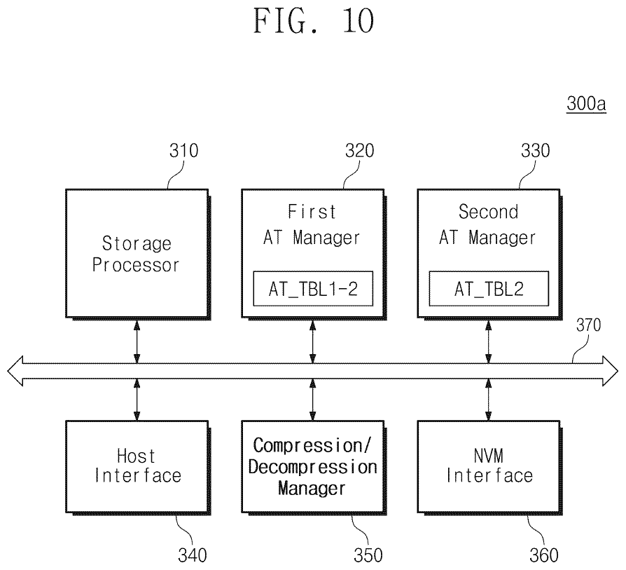

FIG. 10 is a block diagram of a storage controller 300a of FIG. 1, according to some example embodiments.

The storage controller 300a of FIG. 10 may further include a compression/decompression manager 350. The storage controller 300a of FIG. 10 may be same as or similar in some respects to the storage controller 300 of FIG. 4, and therefore may be best understood with reference thereto where like numerals indicate like elements not described again in detail.

The compression/decompression manager 350 may compress and/or decompress pieces of data which the storage controller 300a receives or outputs.

In some example embodiments, the compression/decompression manager 350 may compress data received from a first host processor before storing the received data in non-volatile memories and may decompress data read from the non-volatile memories before transmitting the read data to a second host processor.

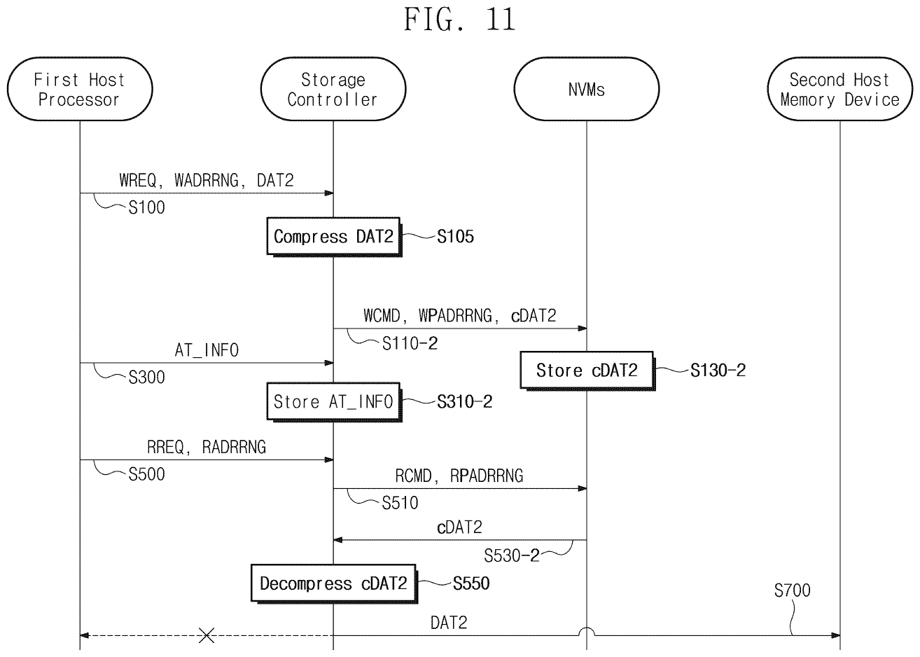

FIG. 11 is a flowchart of an operating operation of an electronic system including a storage controller of FIG. 10, according to some example embodiment.

In the example embodiment illustrated in FIG. 11, the data DAT2 may be compressed before writing the data DAT2 in non-volatile memories, and data read from the non-volatile memories may be decompressed before transmitting the read data to a second host processor. The storage controller of FIG. 11 may be same as or similar in some respects to the storage controller 11 of FIG. 4, and therefore may be best understood with reference thereto where like numerals indicate like elements not described again in detail.

A first host processor (e.g., 150 of FIG. 1) may transmit the write request WREQ, the write logical address range WADRRNG, and the data DAT2 to a storage controller (e.g., 210 of FIG. 1) (S100).

The storage controller may compress the data DAT2 (S105).

The storage controller may transmit the write command WCMD, the write physical address range WPADRRNG, and compressed data cDAT2 to non-volatile memories (e.g., 250 of FIG. 1) based on the write request WREQ and the write logical address range WADRRNG (S110-2), and the non-volatile memories may store the compressed data cDAT2 in the non-volatile memories based on the write command WCMD and the write physical address range WPADRRNG (S130-2).

The first host processor may transmit the first address translation information AT_INFO to the storage controller.

The storage controller may store the first address translation information AT_INFO (S310-2).

In some example embodiments, as in the data DAT2, the first address translation information AT_INFO may also be compressed before the first address translation information AT_INFO is stored in the non-volatile memories; to transmit data read from the non-volatile memories to the second host processor, the first address translation information AT_INFO may be decompressed by the storage controller before referring to the first address translation information AT_INFO. For example, in some example embodiments illustrated in FIG. 8, when the first address translation information AT_INFO is received from the first host processor 100 at a time point at which the storage device 200 is initialized, the first address translation information AT_INFO may have a compressed form between time points (e.g., from operation S300-1 to operation S700 of FIG. 8), but example embodiments are not limited thereto. The first host processor may transmit the read request RREQ and the read logical address range RADRRNG to the storage controller (S500).

The storage controller may transmit the read command RCMD and the read physical address range RPADRRNG to the non-volatile memories based on the read request RREQ and the read logical address range RADRRNG (S510) and may read the compressed data cDAT2 from the non-volatile memories based on the read command RCMD and the read physical address range RPADRRNG (S530-2).

The storage controller may decompress the compressed data cDAT2 (S550).

The storage controller may transmit the data DAT2 to a second host memory device (e.g., 150 of FIG. 1) based on receiving the read request RREQ from the first host processor and the first address translation information AT_INFO (S700).

In some example embodiments, in the electronic system 10 of FIG. 1, even though the descriptions are given with reference to FIGS. 6, 8, and 9, applicable, the data DAT2 may be compressed by the first host processor so as to be transmitted to the second host memory device through the storage controller in the compressed form, and the data DAT2 of the compressed form may be decompressed by the second host processor. In the embodiment illustrated in FIG. 11, the storage controller may perform compression or decompression instead of the first host processor or the second host processor. In this case, the compression or decompression by the first host processor or the second host processor may be offloaded to the storage controller (or the storage device).

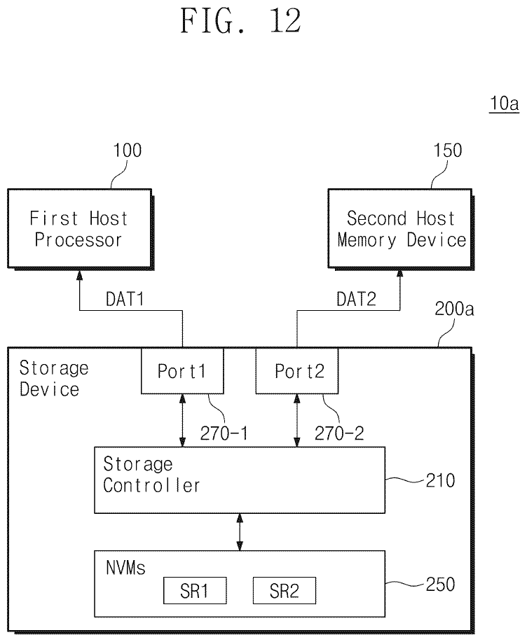

FIG. 12 is a block diagram of an electronic system 10a including a storage device including a storage controller according to some example embodiments.

In an electronic system 10a illustrated in FIG. 12, a storage device 200a may further include a first port 270-1 and a second port 270-2.

In some example embodiments, the storage device 200a may communicate with a plurality of processors through a multi-port.

For convenience of description, the first host memory device 110, the second host processor 130, the host interface 211, the storage processor 213, and the buffer memory 230 are omitted in the electronic system 10a. The first host memory device 110, the second host processor 130, the host interface 211, the storage processor 213, and the buffer memory 230 of FIG. 11 may be same as or similar in some respects to the similar components in FIG. 4, and therefore may be best understood with reference thereto where like numerals indicate like elements not described again in detail.

Referring to FIG. 12, the write data WDAT of FIG. 1 may be transmitted through the first port 270-1 of the storage device 200a in response to that the write data WDAT are transmitted to the first host processor 100, and the write data WDAT may be transmitted through the second port 270-2 of the storage device 200a in response to that the write data WDAT are transmitted to the second host memory device 150.

As described with reference to FIG. 1, data DAT1 may be data scheduled to be processed by the first host memory device 110, and the data DAT2 may be data scheduled to be processed by a second host processor (e.g., 130 of FIG. 1). For example, the data DAT1 may be transmitted through the first port 270-1, and the data DAT2 may be transmitted through the second port 270-2.

In some example embodiments, as the electronic system 10a transmits the data DAT1 and the data DAT2 to the first host memory device 110 and the second host processor respectively by using different ports, the electronic system 10a may increase or improve the efficiency at the system level together with transmitting the data DAT2 directly to the second host memory device 150. For example, the non-volatile memories 250 may include storage regions SR1 and SR2, the data DAT1 may be stored in the storage region SR1, and the data DAT2 may be stored in the storage region SR2. The data DAT1 stored in the storage region SR1 may be transmitted through the first port 270-1, and the data DAT2 stored in the storage region SR2 may be transmitted through the second port 270-2. However, example embodiments are not limited thereto.

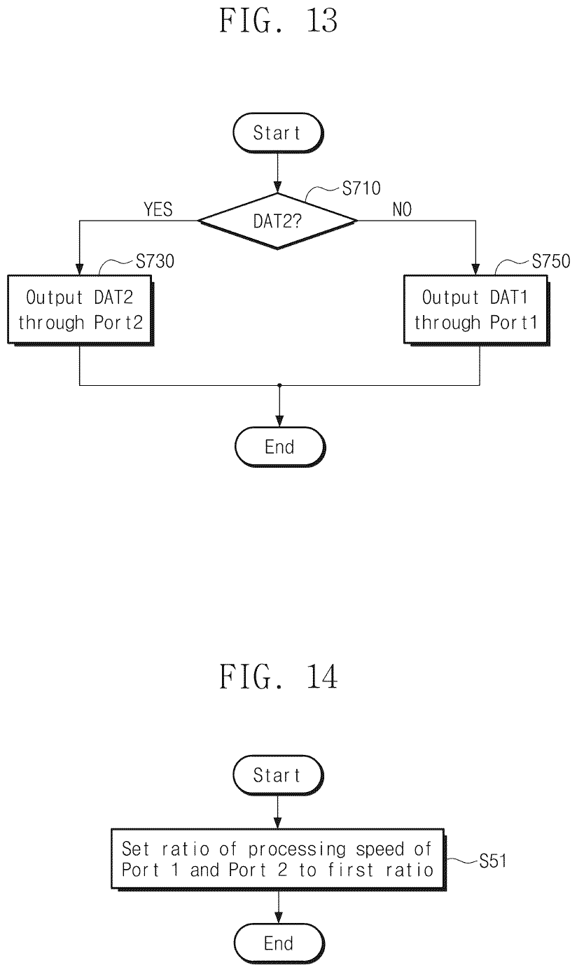

FIG. 13 is a flowchart for describing of a method of operating a storage controller of FIG. 12, according to example embodiments.

In FIG. 13, the transmission of the data DAT2 to the second host memory device in operation S700 of FIGS. 6, 8, 9, and 11 may be performed by the electronic system 10a illustrated in FIG. 12.

Referring to FIGS. 12 and 13, whether data are data scheduled to be processed by a second host processor may be determined (S710).

In some example embodiments, operation S710 may be performed by the storage controller 210.

In response to determining that the data is scheduled to be processed by the second host processor (Yes in S710), the data DAT2 may be transmitted to the second host memory device 150 through the second port 270-2 (S730).

In response to determining that the data is not data scheduled to be processed by the second host processor (No in S710), the data DAT1 may be transmitted to the first host processor through the first port 270-1 (S750).

In some example embodiments, operation S700 may include operation S710, operation S730, and operation S750.

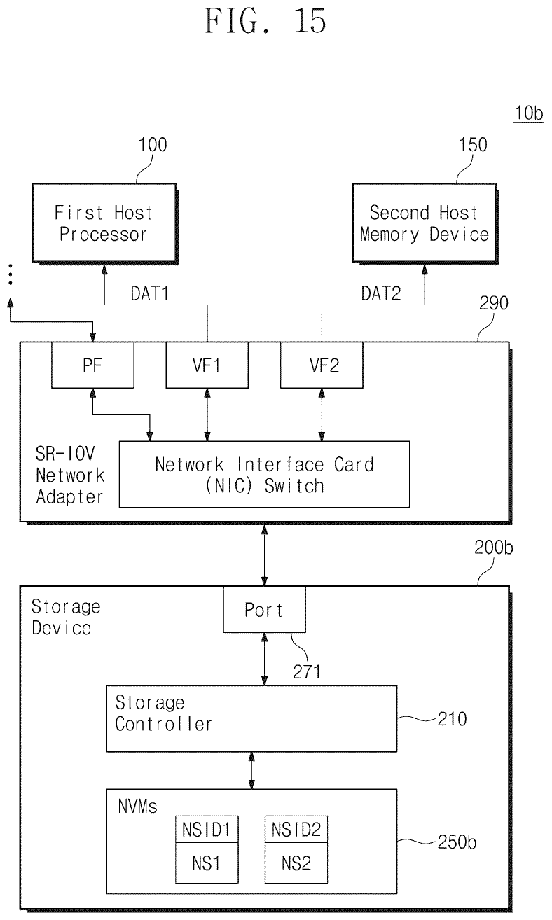

FIG. 14 is a flowchart of a method of operating a storage controller of FIG. 12, according to example embodiments.

In FIG. 14, the storage controller 210 of FIG. 12 may adjust processing speeds of ports which the storage device 200a includes.

Referring to FIG. 14, the storage controller 210 may set a ratio of processing speeds of the first port 270-1 and the second port 270-2 to a first ratio (S51).

In some example embodiments, the second port 270-2 may be a dedicated port of the storage device 200a for communication with the second host memory device 150, and the storage controller 210 may set the ratio of the processing speeds of the dedicated port and the first port 270-1 to the first ratio. For example, the data DAT1 may be transmitted through the first port 270-1, and the data DAT2 may be transmitted through the second port 270-2. When the throughput of the data DAT1 is greater than the throughput of the data DAT2, the processing speed of the first port 270-1 may be increased to be higher than the processing speed of the second port 270-2; and when the throughput of the data DAT1 is smaller than the throughput of the data DAT2, the processing speed of the second port 270-2 may be increased to be higher than the processing speed of the first port 270-1.

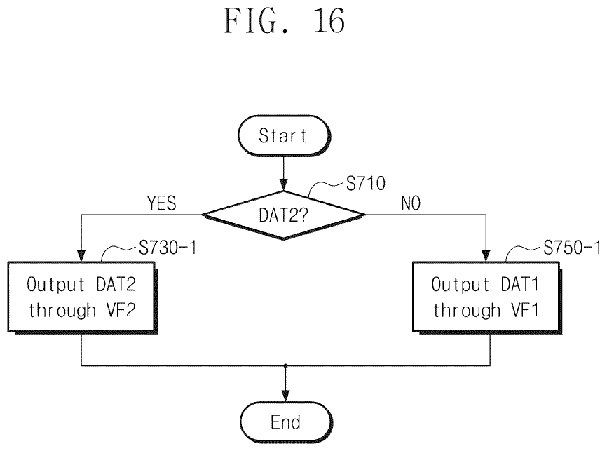

FIG. 15 is a block diagram of an electronic system including a storage device including a storage controller according to some example embodiments.

The electronic system 10b illustrated in FIG. 15 may further include a single root I/O visualization (SR-IOV) network adapter 290.

In some example embodiments, a storage device 200b may communicate with a plurality of processors through a single port, for example, port 271.

For convenience of description, the first host memory device 110, the second host processor 130, the host interface 211, the storage processor 213, and the buffer memory 230 are omitted in the electronic system 10B. The first host memory device 110, the second host processor 130, the host interface 211, the storage processor 213, and the buffer memory 230 may be same as or similar in some respects to the first host memory device 110, the second host processor 130, the host interface 211, the storage processor 213, and the buffer memory 230 of FIG. 1, and therefore may be best understood with reference thereto where like numerals indicate like elements not described again in detail.

Referring to FIG. 15, the SR-IOV network adapter 290 may include a physical function PF, virtual functions VF1 and VF2, and a network interface card (NIC) switch.

The physical function PF may be connected to a host device including the first host processor 100, a first host memory device, a second host processor, and the second host memory device 150, and the virtual functions VF1 and VF2 may be derived from the physical function PF. For example, the virtual function VF1 may be connected to the first host processor 100, and the virtual function VF2 may be connected to the second host memory device 150.

In some example embodiments, the storage device 200b may communicate with a plurality of processors through the virtual functions VF1 and VF2 of the SR-IOV network adapter 290 and a port 271.

The write data WDAT of FIG. 1 may be transmitted through the port 271 of the storage device 200b and the SR-IOV network adapter 290 in response to that the write data WDAT are transmitted to the first host processor 100, and the write data WDAT may be transmitted through the port 271 and the virtual function VF2 in response to that the write data WDAT are transmitted to the second host memory device 150.

Even though illustrated in FIG. 15, the physical function PF and the virtual functions VF1 and VF2 may be included in the storage device 200b. In some example embodiments, the physical function PF may be the storage device 200b itself, which is capable of corresponding to the PCIe device.

In some example embodiments, as the electronic system 10b transmits the data DAT1 and the data DAT2 to the first host processor 100 and the second host processor respectively by using different virtual functions, the electronic system 10b may increase the efficiency at the system level together with transmitting the data DAT2 directly to the second host memory device 150. For example, non-volatile memories 250b may include namespaces NS1 and NS2 to which namespace IDs NSID1 and NDID2 are respectively assigned, the data DAT1 may be stored in the namespace NS1, and the data DAT2 may be stored in the namespace NS2. The data DAT1 stored in the namespace NS1 may be transmitted through the virtual function VF1, and the data DAT2 stored in the namespace NS2 may be transmitted through the virtual function VF2. However, example embodiments are not limited thereto.

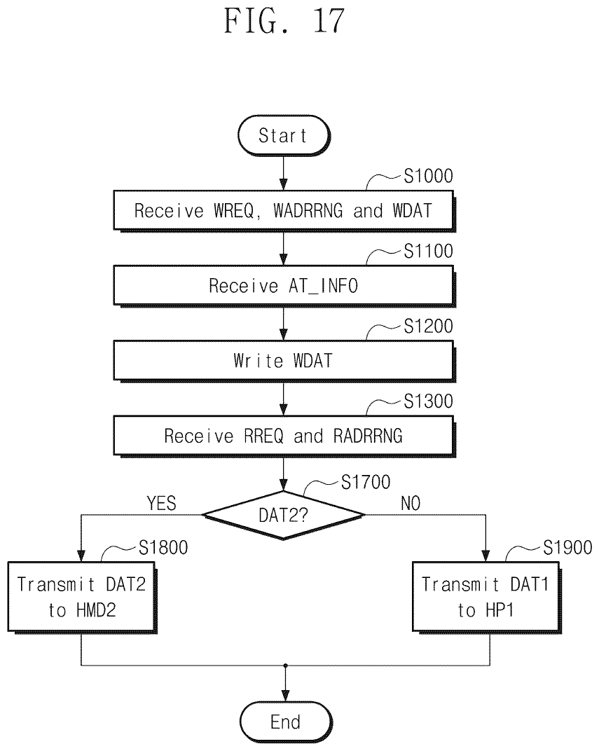

FIG. 16 is a flowchart for describing of a method of operating a storage controller of FIG. 15.

In FIG. 16, the transmission of the data DAT2 to the second host memory device in operation S700 of FIGS. 6, 8, 9, and 11 may be performed by the electronic system 10b illustrated in FIG. 15.

Referring to FIGS. 15 and 16, whether data are data scheduled to be processed by a second host processor may be determined (S710).

In some example embodiments, operation S710 may be performed by the storage controller 210.

In response to that the data are data scheduled to be processed by the second host processor (Yes in S710), the data DAT2 may be transmitted to the second host memory device 150 through the virtual function VF2 (S730-1).

In response to determining that the data are not scheduled to be processed by the second host processor (No in S710), the data DAT1 may be transmitted to the first host processor through the virtual function VF1 (S750-1).

In some example embodiments, operation S700 may include operation S710, operation S730-1, and operation S750-1.

FIG. 17 is a flowchart for describing a method of operating a storage controller according to some example embodiments of the present disclosure.

Referring to FIG. 17, the write request WREQ, the write logical address range WADRRNG, and the write data WDAT may be received from a first host processor (S1000).

The first address translation information AT_INFO between the write logical address range WADRRNG and a storage region of a second host memory device associated with a second host processor may be received from the first host processor (S1100).

The write data WDAT may be written in non-volatile memories of a storage device based on the write request WREQ and the write logical address range WADRRNG (S1300).

The read request RREQ and the read logical address range RADRRNG associated with the write data WDAT may be received from the first host processor (S1500).

In response to receiving the read request RREQ and the read logical address range RADRRNG, whether the write data WDAT are scheduled to be processed by the second host processor may be determined based on the first address translation information AT_INFO (S1700).

The write data WDAT may be transmitted to one of the first host processor and the second host processor based on a result of the determination (S1800 and S1900).

In some example embodiments, operation S1300 may include writing the write data WDAT based on first address translation information and second address translation information. The second address translation information may include mapping information between the write logical address range WADRRNG and a storage region of the non-volatile memories.

In some example embodiments, operation S1700 may include determining whether the first address translation information includes the read logical address range RADRRNG.

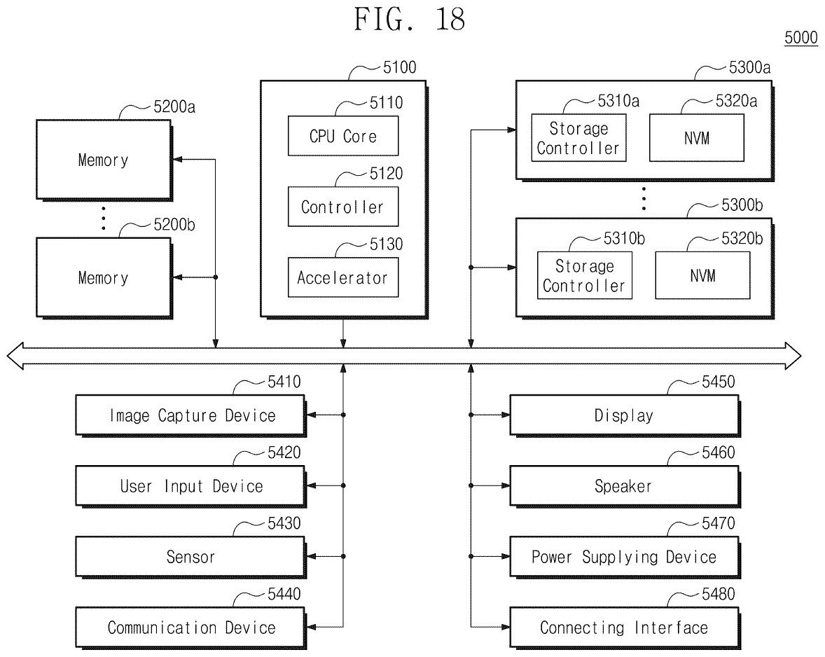

FIG. 18 is a block diagram illustrating an electronic system 5000 including a storage controller according to some example embodiments.

The electronic system 5000 of FIG. 18 may be a mobile system, such as a portable communication terminal (e.g., a mobile phone), a smartphone, a tablet personal computer (PC), a wearable device, a healthcare device, or an Internet of things (IOT) device. However, the electronic system 5000 of FIG. 18 is not necessarily limited to the mobile system and may be a PC, a laptop computer, a server, a media player, or an automotive device (e.g., a navigation device).

Referring to FIG. 18, the electronic system 5000 may include a main processor 5100, memories (e.g., 5200a and 5200b), and storage devices (e.g., 5300a and 5300b). In addition, the electronic system 5000 may include at least one of an image capturing device 5410, a user input device 5420, a sensor 5430, a communication device 5440, a display 5450, a speaker 5460, a power supplying device 5470, and a connecting interface 5480.

The main processor 5100 may control all operations of the electronic system 5000, including, for example, operations of other components included in the electronic system 5000. The main processor 5100 may be implemented as a general-purpose processor, a dedicated processor, or an application processor.

The main processor 5100 may include at least one CPU core 5110 and further include a controller 5120 configured to control the memories 5200a and 5200b and/or the storage devices 5300a and 5300b. In some embodiments, the main processor 5100 may further include an accelerator 5130, which is a dedicated circuit for a high-speed data operation, such as an artificial intelligence (AI) data operation. The accelerator 5130 may include a graphics processing unit (GPU), a neural processing unit (NPU) and/or a data processing unit (DPU) and be implemented as a chip that is physically separate from the other components of the main processor 5100.

The memories 5200a and 5200b may be used as main memory devices of the electronic system 5000. Although each of the memories 5200a and 5200b may include a volatile memory, such as static random access memory (SRAM) and/or dynamic RAM (DRAM), each of the memories 5200a and 5200b may include non-volatile memory, such as a flash memory, phase-change RAM (PRAM) and/or resistive RAM (RRAM). The memories 5200a and 5200b may be implemented in the same package as the main processor 5100.

The storage devices 5300a and 5300b may serve as non-volatile storage devices configured to store data regardless of whether power is supplied thereto, and have relatively larger storage capacity than the memories 5200a and 5200b. The storage devices 5300a and 5300b may respectively include storage controllers (STRG CTRL) 5310a and 5310b and NVM (Non-Volatile Memory) 5320a and 5320b configured to store data via the control of the storage controllers 5310a and 5310b. Although the NVMs 5320a and 5320b may include flash memories having a two-dimensional (2D) structure or a three-dimensional (3D) V-NAND structure, the NVMs 5320a and 5320b may include other types of NVMs, such as PRAM and/or RRAM.

The storage devices 5300a and 5300b may be separated (e.g., physically) from the main processor 5100 and included in the electronic system 5000 or implemented in the same package as the main processor 5100. In addition, the storage devices 5300a and 5300b may have types of solid-state devices (SSDs) or memory cards and be removably combined with other components of the electronic system 5000 through an interface, such as the connecting interface 5480 that will be described below. The storage devices 5300a and 5300b may be devices to which a standard protocol, such as a universal flash storage (UFS), an embedded multi-media card (eMMC), or a non-volatile memory express (NVMe), is applied, without being limited thereto.

The image capturing device 5410 may capture still images or moving images. The image capturing device 5410 may include a camera, a camcorder, and/or a webcam.

The user input device 5420 may receive various types of data input by a user of the electronic system 5000 and include a touch pad, a keypad, a keyboard, a mouse, and/or a microphone.

The sensor 5430 may detect various types of physical quantities, which may be obtained from the outside of the electronic system 5000, and convert the detected physical quantities into electric signals. The sensor 5430 may include a temperature sensor, a pressure sensor, an illuminance sensor, a position sensor, an acceleration sensor, a biosensor, and/or a gyroscope sensor.

The communication device 5440 may transmit and receive signals between other devices outside the electronic system 5000 according to various communication protocols. The communication device 5440 may include an antenna, a transceiver, and/or a modem.

The display 5450 and the speaker 5460 may serve as output devices configured to respectively output visual information and auditory information to the user of the electronic system 5000.

The power supplying device 5470 may appropriately convert power supplied from a battery embedded in the electronic system 5000 and/or an external power source, and supply the converted power to each of components of the electronic system 5000.

The connecting interface 5480 may provide connection between the electronic system 5000 and an external device, which is connected to the electronic system 5000 and capable of transmitting and receiving data to and from the electronic system 5000. The connecting interface 5480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface. In some example embodiments, the CPU core 5110 may be a first host processor (e.g., 100 of FIG. 1), and the accelerator 5130 may be a second host processor (e.g., 130 of FIG. 1). The memories 5200a and 5200b may include a first host memory device (e.g., 110 of FIG. 1) and a second host memory device (e.g., 150 of FIG. 1).

In some example embodiments, the storage devices 5300a and 5300b may be storage devices (e.g., 200 of FIG. 1, 200a of FIG. 12, and 200b of FIG. 15). The storage devices 5300a and 5300b may perform the method of operating the storage controller. according to example embodiments of the present disclosure.

As described above, when data transmitted from a first host processor is scheduled to be processed by a second host processor, a storage controller may directly transmit the data to a second host memory device associated with the second host processor, instead of the first host processor, based on address translation information. Also, the storage controller may perform the transmission to the second host memory device through a dedicated port of the storage device and may set or adjust the processing speed of the dedicated port. Accordingly, in an electronic system including the first host processor, the second host processor, and the storage device, it may be possible to provide a memory architecture reducing or limiting the overhead occurring at the first host processor and increasing the efficiency at the system level of the electronic system.

Any or all of the elements described with reference to FIGS. 1, 4, 10, 12, 15, 18 may communicate with any or all other elements described with reference to FIG. 1, 4, 10, 12, 15, 18. For example, any element may engage in one-way and/or two-way and/or broadcast communication with any or all other elements in any of the figures, to transfer and/or exchange and/or receive information such as but not limited to data and/or commands, such as in a serial and/or parallel manner, via a bus such as a wireless and/or a wired bus. The information may be in encoded various formats, such as in an analog format and/or in a digital format, without being limited thereto.

As described herein, any devices, systems, modules, portions, units, controllers, circuits, and/or portions thereof according to any of the example embodiments, and/or any portions thereof (including, without limitation, the first host processor 100, the first host memory device 110, the second host processor 130, the second host memory device 150, the storage device 200, storage device 200a, the first port 270-1, the second port 270-2, storage device 200b, the port 271, the storage controller 210, the buffer memory 230, the non-volatile memories (NVMs) 250, the single root I/O visualization (SR-IOV) network adapter 290, the host interface 211, the storage processor 213, the storage processor 310, the first address translation (AT) manager 320, the second address translation manager 330, the host interface 340, the NVM interface 360, the memory cell array 510, the address decoder 520, the page buffer circuit 530, the data input/output circuit 540, the control circuit 550, the voltage generator 560, the main processor 5100, the memories 5200a and 5200b, the storage devices 5300a and 5300b, the CPU core 5110, the controller 5120, the accelerator 5130, the storage controllers 5310a and 5310b, the non-volatile memories 5320a and 5320b, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

1. A storage controller comprising:
a host interface configured to receive a write request, a write logical address range, and write data from a first host processor and to receive first address translation information between the write logical address range and a storage region of a second host memory device associated with a second host processor; and
a storage processor configured to transmit the write data to at least one non-volatile memory of a storage device and to transmit the write data to the second host memory device based on receiving a read request for the write data from the first host processor and the first address translation information.

2. The storage controller of claim 1, wherein the write data is scheduled to be processed by the second host processor.

3. The storage controller of claim 2, wherein the storage controller is configured to determine whether the write data is scheduled to be processed by the second host processor based on one of the write request and the first address translation information.

4. The storage controller of claim 3, wherein the storage controller is configured to, in response to determining that the write data is scheduled to be processed by the second host processor, receive the first address translation information after receiving the write request, the write logical address range, and the write data.

5. The storage controller of claim 1, wherein the first address translation information includes mapping information between the write logical address range and a physical address range of the storage region of the second host memory device.

6. The storage controller of claim 5, wherein the first address translation information is generated by the first host processor using a memory management device associated with the first host processor.

7. The storage controller of claim 1, wherein the storage controller includes:
a first address translation manager configured to manage the first address translation information; and
a second address translation manager configured to manage second address translation information between the write logical address range and a storage region of the at least one non-volatile memory.

8. The storage controller of claim 7, wherein the storage controller is configured to update the first address translation information and the second address translation information in response to the write data being changed in the at least one non-volatile memory.

9. The storage controller of claim 7, wherein the storage controller further includes:
a compression/decompression manager configured to compress/decompress the write data.

10. The storage controller of claim 9, wherein the storage controller is configured to:
compress the write data before the write data is written in the at least one non-volatile memory, in response to receiving the write data from the first host processor; and
decompress the write data before the write data is transmitted to the second host processor, in response to receiving the read request for the write data from the first host processor.

11. The storage controller of claim 1, wherein the storage controller is configured to implement an address translation service (ATS) based on the first address translation information.

12. The storage controller of claim 1, wherein the storage controller is configured to store the first address translation information in a buffer memory of the storage device or the at least one non-volatile memory.

13. The storage controller of claim 1, wherein the storage controller is configured to transmit the write data to the second host processor through a dedicated port of the storage device in response to receiving the read request for the write data from the first host processor, the dedicated port of the storage device being configured to communicate with the second host memory device.

14. The storage controller of claim 1, wherein the storage controller is configured to set, to a first ratio, a ratio of a processing speed of a dedicated port of the storage device for communication with the second host memory device and a processing speed of another port of the storage device for communication with the first host processor.

15. A method of operating a storage controller, the method comprising:
receiving a write request, a write logical address range, and write data from a first host processor;
receiving first address translation information between the write logical address range and a storage region of a second host memory device associated with a second host processor from the first host processor;
transmitting the write data to at least one non-volatile memory of a storage device based on the write request and the write logical address range;
determining whether the write data is scheduled to be processed by the second host processor based on the first address translation information, in response to receiving a read request and a read logical address range for the write data from the first host processor; and
transmitting the write data to one of the first host processor and the second host memory device based on a result of the determining.

16. The method of claim 15, wherein the transmitting of the write data to the at least one non-volatile memory of the storage device includes:
transmitting the write data based on the first address translation information and second address translation information, and
wherein the second address translation information includes mapping information between the write logical address range and a storage region of the at least one non-volatile memory.

17. The method of claim 16, wherein the determining whether the write data is scheduled to be processed by the second host processor includes:
determining whether the first address translation information includes the read logical address range.

18. A storage controller comprising:
a host interface configured to receive a write request, a write logical address range, and write data from a first host processor and to receive address translation information between the write logical address range and a storage region of a second host memory device associated with a second host processor; and
a storage processor configured to:
transmit the write data to at least one non-volatile memory of a storage device based on the write request and the write logical address range;
determine whether the write data is scheduled to be processed by the second host processor, based on the address translation information, in response to receiving a read request for the write data from the first host processor; and
transmit the write data to one of the first host processor and the second host memory device based on a result of the determination.

19. The storage controller of claim 18, wherein the storage processor is configured to transmit the write data through a first port of the storage device in response to the result of the determination being that the write data is transmitted to the first host processor, and
wherein the storage processor is configured to transmit the write data through a second port of the storage device in response to the result of the determination being that the write data is transmitted to the second host memory device.

20. The storage controller of claim 18, wherein the write data is transmitted through a first virtual function of a single root I/O visualization (SR-IOV) network adapter in response to the write data being transmitted to the first host processor, and
wherein the write data is transmitted through a second virtual function of the SR-IOV network adapter in response to the write data being transmitted to the second host memory device.
